(19) United States
(12) Patent Application Publication
(10) Pub. No.: US 2023/0395007 A1
(43) Pub. Date: Dec. 7, 2023

(54) DISPLAY DEVICE, DISPLAY SYSTEM, AND DISTRIBUTED FUNCTIONAL SYSTEM

(71) Applicant: WUHAN CHINA STAR OPTOELECTRONICS TECHNOLOGY CO., LTD., Wuhan (CN)

(72) Inventors: Zhou Zhang, Wuhan (CN); Zhifu Li, Wuhan (CN); Guowei Zha, Wuhan (CN); Guanghui Liu, Wuhan (CN)

(73) Assignee: WUHAN CHINA STAR OPTOELECTRONICS TECHNOLOGY CO., LTD., Wuhan (CN)

(21) Appl. No.: 17/267,792

(22) PCT Filed: Dec. 29, 2020
(86) PCT No.: PCT/CN2020/140521

§ 371 Date: Jul. 9, 2023

(30) Foreign Application Priority Data
Dec. 15, 2020 (CN) 202011469303.X

(51) Int. Cl. G09G 3/20

(52) U.S. Cl. CPC G09G 3/20; G09G 2370/16

(57) ABSTRACT

The present application provides a display device, a display system, and a distributed functional system. The display device includes display modules and first functional units. Each of the display modules is configured to receive a corresponding display signal, each of the display modules includes display units, and a parameter of each of the display signals is less than or equal to a peak processing capability of the corresponding display module. Each of the first functional units is arranged between adjacent ones of the display units.

### FIELD OF DISCLOSURE

The present application relates to the field of display technology and in particular, to a display device, a display system and a distributed functional system.

### DESCRIPTION OF RELATED ART

At present, large-screen display devices with full high definition (FHD) and higher-than-FHD resolutions are the development trend in the display field. High-resolution display devices need to transmit a larger amount of data, and it requires a higher data transfer rate to transmit a larger amount of data. A system is usually integrated in a system-on-panel (referred to as “SOP”) display device. The SOP display device is carried out by integrating a system function in a non-display region of the display panel, but a proportion of a display region drops seriously, which is not in line with the current full-screen trend; or the SOP display device is carried out by integrating system functions in gaps between pixels in the display region of the display panel, but high data transmission rates (such as 1000 MHz) are not possible, resulting in limitations on developing SOP display panels to have large screens with FHD and resolutions higher than FHD.

Therefore, it is necessary to provide a technical solution to solve the problem that the conventional SOP display devices cannot provide higher data transmission rates, which limits the development of display devices with FHD or higher-than-FHD resolutions.

### SUMMARY OF INVENTION

### Technical Problem

It is an objective of the present application provides a display device, a display system and a distributed functional system, which is beneficial to system-on-panel (SOP) display devices to realize high-resolution display.

### SOLUTION TO PROBLEM

### Technical Solution

Accordingly, the present application provides solutions as follows.

A display device, comprising:
a plurality of display modules, wherein each of the display modules is configured to receive a corresponding display signal, each of the display modules comprises a plurality of display units, a parameter of each of the display signals is less than or equal to peak processing capability of the corresponding display module; and a plurality of first functional units, each of the first functional units arranged between adjacent ones of the display units.

The present application further provides a display system, comprising at least one display device mentioned above.

The present application provides a distributed functional system, comprising:
a plurality of functional modules, wherein each of the functional modules is configured to receive a corresponding functional signal, and a parameter of each of the functional signals is less than or equal to peak processing capability of the corresponding functional module; and
a signal splitting module configured to split a signal received by the signal splitting module into the functional signal.

### ADVANTAGES OF INVENTION

### Beneficial Effect

The present application provides a display device, a display system, and a distributed functional system. The display device includes multiple distributed display modules, each display module receives its own corresponding display signal, and each display module includes multiple display units, and each first functional unit is integrated between adjacent ones of the display units to realize the functional integration in the display device. A parameter of each display signal is less than or equal to peak processing capability of the corresponding display module, so that the above-mentioned distributed system-on-panel (SOP) display device can realize the full high definition (FHD) displays or higher-than-FHD resolution displays.

### BRIEF DESCRIPTION OF DRAWINGS

### Description of Attached Drawings

FIG. 1 is a first schematic plan view of a display device according to one embodiment of the present application.

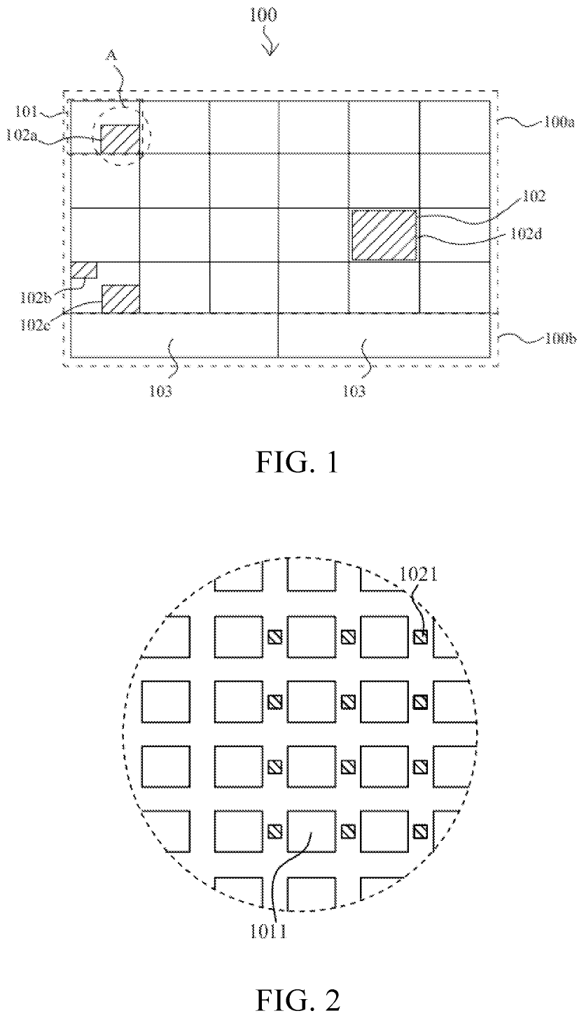

FIG. 2 is a partial enlarged schematic view illustrating portion A in FIG. 1.

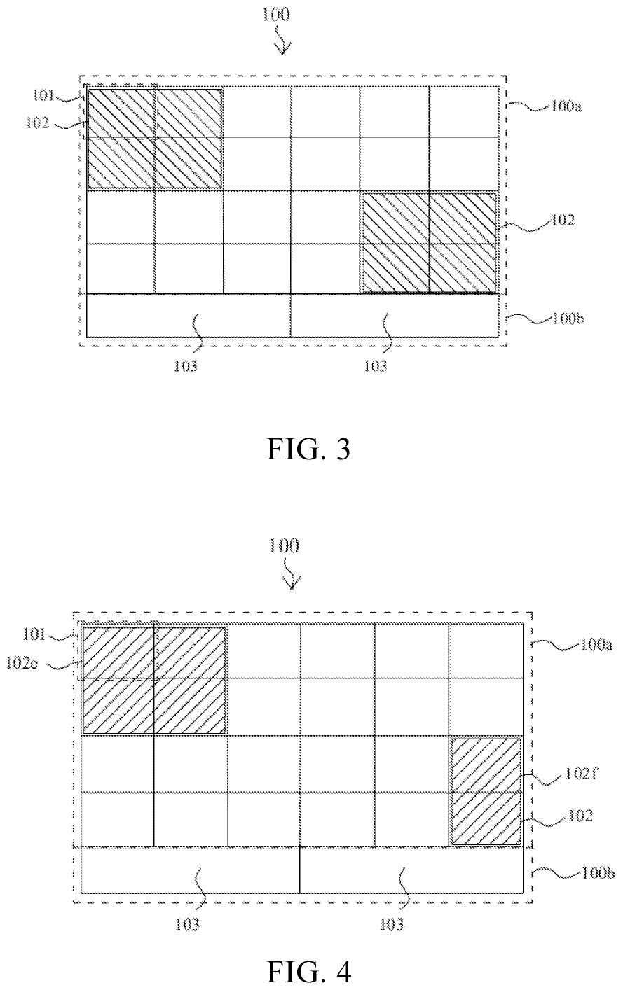

FIG. 3 is a second plan view illustrating the display device according to one embodiment of the present application.

FIG. 4 is a third plan view illustrating the display device according to one embodiment of the present application.

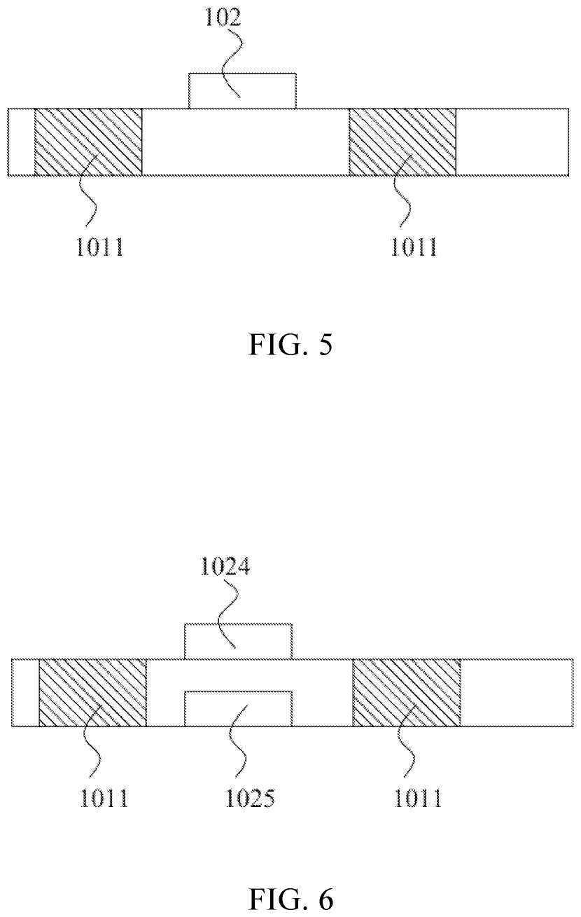

FIG. 5 is a first cross-sectional view illustrating the display device according to one embodiment of the present application.

FIG. 6 is a second cross-sectional view illustrating the display device according to one embodiment of the present application.

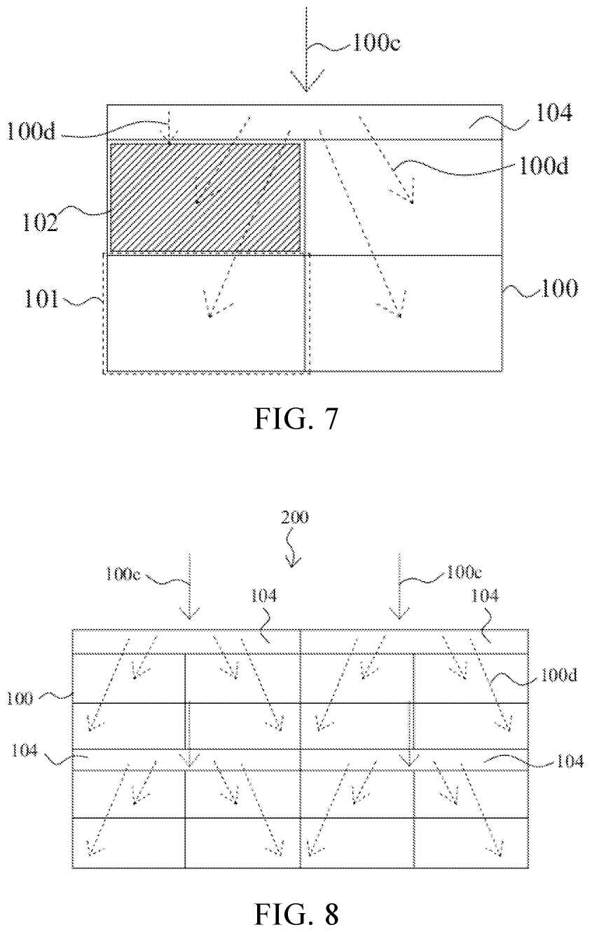

FIG. 7 is a fourth plan view illustrating the display device according to one embodiment of the application.

FIG. 8 is a first schematic view illustrating a display system according to one embodiment of the present application.

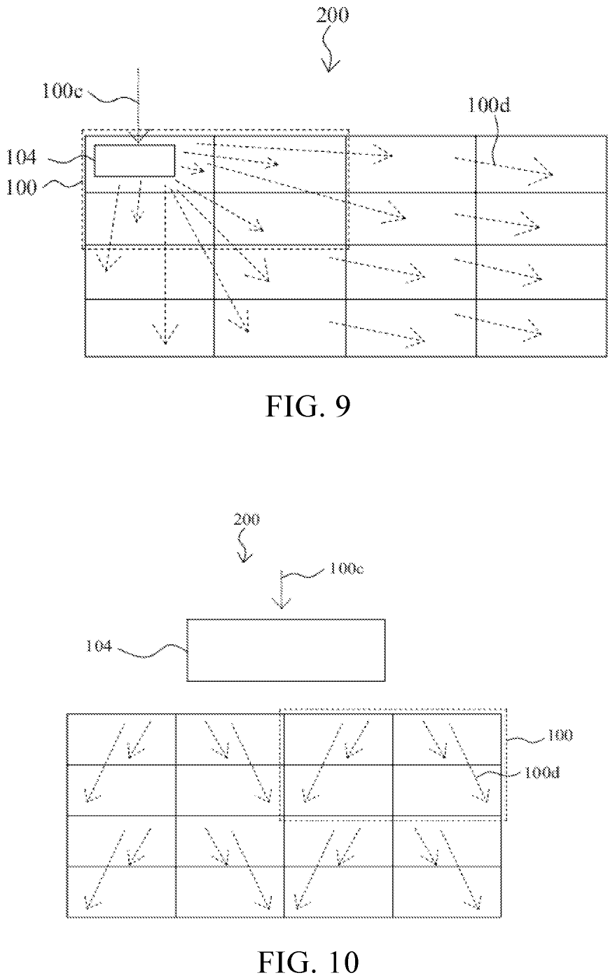

FIG. 9 is a second schematic view illustrating the display system according to one embodiment of the present application.

FIG. 10 is a third schematic view illustrating the display system according to one embodiment of the present application.

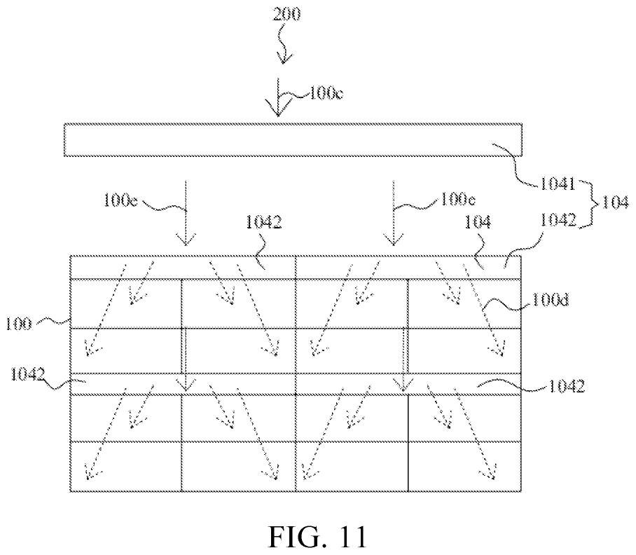

FIG. 11 is a fourth schematic view illustrating the display system according to one embodiment of the present application.

Reference signs as follows:

100 display device; 100a display region; 100b non-display region; 101 display module; 1011 display unit; 102 first functional module; 102a first functional module A; 102b first functional module B; 102c first functional module C; 102d first functional module D; 102e first functional module E; 102f first functional module F; 1021 first functional unit; 1024 first functional element; 1025 second functional element; 103 second functional module; 104 signal splitting module; 1041 first signal splitting module; 1042 second signal splitting module; 100e intermediate signal; 100d processing signal; 200 display system.

### DETAILED DESCRIPTION OF EMBODIMENTS

The technical solutions of the present application are clearly and completely described below in conjunction with the accompanying drawings with reference to the embodiments of the present application. Obviously, the described embodiments are only some of the embodiments of the present application, rather than all the embodiments. Based on the embodiments in the present application, all other embodiments obtained by those skilled in the art without inventiveness should be deemed to fall within the protection scope of the present application.

Regarding the problem that it is difficult for a conventional display device with a system integrated into a display panel to develop into large-screen high-resolution displays, the main reason is that the display panel and functional devices that make up the conventional display device are composed of thin film transistors, capacitors, or resistors which only have the ability to process signals of some certain frequencies. When these components input signals with signal frequencies beyond their processing capabilities, problems such as failure will occur, which causes the display panel or the functional devices to fail to function normally. In particular, the thin film transistors made by physical deposition, chemical deposition, and etching techniques on the display panel are limited by manufacturing processes. As a result, peak processing capability of the devices in the traditional display panel is limited by manufacturing processes, and the processing capability of the above-mentioned components cannot be simply improved to achieve the purpose of processing high-frequency signals.

In light of the above limitations, a display device disclosed in the present embodiment splits a high-frequency external source signal (e.g., above 3 Gbps) into multiple parallel low-frequency signals (e.g., 10 MHz to 300 MHz), and at the same time, the present application provides a distributed display panel composed of multiple display modules that independently receive low-frequency signals and multiple functional modules that independently receive low-frequency signals. A parameter of the split low-frequency signals received by each display module is less than or equal to peak processing capability of a corresponding display module, and a parameter of the split low-frequency signal received by the functional modules is less than or equal to peak processing capability of the functional module, so that the splitting of the high-frequency signal matches the splitting of a display part and a functional part. As a result, the display device with a distributed system integrated into the display panel is obtained. The display device with the distributed system integrated into the display panel can process high-frequency signals and can meet the requirement of processing large amounts of data on display devices with full high definition (FHD) and higher than FHD resolutions.

It should be noted that when the high-frequency signal has a constant signal frequency and the display panel includes a certain number of display units, the splitting of the high-frequency signal, the splitting of the display part, and the splitting of the functional part need to match each other. The splitting of the high-frequency signals, the splitting of the display part, and the splitting of the functional part are not achieved in a mechanical way. If the display part is split into a smaller number of display modules and each display module receives the corresponding low-frequency signal, there is a small number of low-frequency signals split from the corresponding high-frequency signal, and the small number of low-frequency signals leads to a higher signal frequency of the low-frequency signal, and consequently, the signal frequency of the split low-frequency signal still exceeds the peak processing capability of the display module; if the display part is split into a larger number of display modules, there are more low-frequency signals split from the corresponding high-frequency signal, and in this case it is not only difficult to split the high-frequency signal into multiple low-frequency signals, but also difficult to transmit the split low-frequency signals to the corresponding display modules and the corresponding functional modules. In fact, the present application restricts a parameter of a signal received by each display module to be less than or equal to a peak processing capability of a corresponding display module, and a parameter of a signal received by each functional module is less than or equal to a peak processing capability of a corresponding functional module, so that the splitting of a high-frequency signal, the splitting of a display part, and the splitting of a functional part can match each other, that is, the splitting of the high-frequency signal matches the configuration of the display module and the functional module in the display device.

Please refer to FIG. 1, which is a first plan view of a display device according to one embodiment of the present application. The display device 100 can be a liquid crystal display device, an organic light emitting diode (OLED) display device, a micro LED display device, or etc., and the present application is not limited in this regard. The display device 100 has a display region 100a. The display device 100 includes a plurality of display modules 101 and a plurality of first functional modules 102, and the display modules 101 and the first functional modules 102 are all disposed in the display region 100a.

As shown in FIG. 1 and FIG. 2, FIG. 2 is a partial enlarged view illustrating portion A in FIG. 1. The multiple display modules 101 are arranged in a matrix, each display module 101 comprises multiple display units 1011, and the display units 1011 in each display module 101 are arranged in a matrix. For example, each display module 101 comprises two display units 1011, three display units 1011, or more than three display units 1011. Wherein, each display unit 1011 comprises at least one light-emitting element. The light-emitting element can be a liquid crystal unit, a micro-LED, a sub-millimeter light-emitting diode (Mini-LED), an organic light-emitting diode, or etc., and the present application is not limited in this regard. Each display unit 1011 can also include a pixel driving circuit that drives the light-emitting element to emit light. The pixel driving circuit includes a transistor, a capacitor, and etc. The pixel driving circuit can be a 2T1C circuit, a 3T1C circuit, a 4T1C circuit, a 5T1C circuit, a 6T1C circuit, or a 7T1C circuit in conventional technology. In the present embodiment, it is preferable to use a micro-LED as the light-emitting element as an example for description.

In the present embodiment, each display module 101 is configured to receive a corresponding display signal, and a parameter of each display signal is less than or equal to a peak processing capability of the corresponding display module 101, so that each display module 101 can process the display signal within its processing capability, thus constituting an overall distributed display device to thereby effectively process high-frequency signals resulting from high resolution display. Wherein, a parameter of the display signal can be a value corresponding to a signal frequency of the display signal, or can be other characteristic parameters of the display signal. A peak processing capability of the display module can be the maximum value of the signal frequency of the display signal that can be processed by the display unit 1011 with the lowest processing capability among the display units 1011 constituting the display module 101.

The present application splits the display part in conventional technology into multiple display modules 101, each display module 101 comprises a plurality of the display units 1011, and each first functional unit 1021 is arranged between adjacent display units 1011, so that a distributed system-on-panel (SOP) display device is obtained. the parameter of each display signal is less than or equal to the peak processing capability of the corresponding display module 101 to provide the SOP display device 100 with a basis for processing high-frequency signals, so that the SOP display device 100 can realize FHD displays and higher-than-FHD displays.

Referring to FIGS. 1, 2, 3, and 4, the display device 100 comprises the plurality of first functional modules 102, and the first functional modules 102 can comprise at least two first functional modules 102 with the same function. For example, as shown in FIG. 3, there can be multiple first functional modules 102 with the same function. The first functional modules 102 can also comprise multiple first functional modules 102 with different functions, and both FIG. 1 and FIG. 4 show multiple first functional modules 102 with different functions.

As shown in FIG. 2, each first functional module 102 comprises a plurality of first functional units 1021, and each first functional unit 1021 is disposed between adjacent display units 1011. The first functional unit 1021 can be a single component such as a transistor, an inductor, a resistor, or a capacitor, and the first functional unit 1021 can also be composed of multiple components. The first functional unit 1021 can be made by using a conventional display panel manufacturing process. The first functional unit 1021 can also be fixed to the display device 100 by welding, bonding or interface coupling. A portion of the components that constitute the first functional unit 1021 can be made by using a conventional display panel manufacturing process, and another portion of the components that constitute the first functional unit 1021 can also be fixed to the display device 100 by welding, bonding, or interface coupling.

In the present embodiment, the first functional unit 1021 is the same as the display unit 1011. Due to a limited processing capability of the devices that constitute the first functional unit 1021, the first functional unit 1021 has a limited processing capability, which in turn causes a limited processing capability of the first functional module 102 composed of multiple first functional units 1021. The peak processing capability of the first functional module 102 depends on the processing capability of the first functional unit 1021 with the lowest processing capability among the multiple first functional units 1021 constituting the first functional module 102. For example, the peak processing capability of the first functional module 102 depends on the maximum value of a signal frequency of a first functional signal that can be processed by the first functional unit 1021 with the lowest processing capability.

Further, each first functional module 102 is configured to receive a corresponding first functional signal, a parameter of each first functional signal is less than or equal to the peak processing capability of the corresponding first functional module 102, and the first functional modules 102 are arranged in a distributed manner in the display device 100, thereby providing the distributed SOP display device 100 with a basis for processing high-frequency signals.

Preferably, the first functional module 102 comprises one or more of a source driving module, a gate driving module, a timing control module, a read-only memory (ROM) module, a random access memory (RAM) module, a central processing unit (CPU) module, an artificial intelligence (AI) module, an antenna module, an audio module, a sensor module, and a power module. Wherein, the source driving module is obtained by splitting a source driver into multiple parts, and the gate driving module and the timing control module can be obtained by analogy. In practice, a signal received by the display device can be processed by the first functional module before being transmitted to the display module for corresponding displays.

Referring to FIGS. 1, 3, and 4, at least one first functional module 102 is disposed in a region corresponding to one display module 101, and/or multiple display modules 101 are disposed in a region corresponding to one first functional module 102. This way, the first functional modules 102 are arranged in a distributed manner in the regions corresponding to the display modules 101 to thereby realize a distributed SOP display device.

Specifically, as shown in FIG. 1, the first functional modules 102 comprise a first functional module A 102a, a first functional module B 102b, a first functional module C 102c, and a first functional module D 102d. The first functional module A 102a, the first functional module B 102b, the first functional module C 102c, and the first functional module D 102d have functions different from each other.

One first functional module 102 can be set in a region corresponding to one display module 101, and the region corresponding to the first functional module 102 only occupies a part of the region corresponding to one display module 101. That is, one first functional module 102 only occupies gaps between some display units 1011 of one display module 101. For example, the first functional module A 102a is arranged in a portion of the region corresponding to one display module 101.

The first functional module 102 can be arranged in a display module 101, and an area of the region corresponding to the first functional module 102 is almost equal to an area of the region corresponding to the display module 101. For example, the first functional module D 102d can also be arranged in all gaps between multiple display units 1011 in one display module 101.

The first functional modules 102 with different functions can be integrated in a region corresponding to one display module 101. For example, the first functional module B 102b and the first functional module C 102c with different functions are integrated in a region corresponding to the same display module 101. Wherein, the first functional module B 102b and the first functional module C 102c are spaced apart, and an area of a region corresponding to the first functional module B 102b can be different from or equal to an area of a region corresponding to the first functional module C 102c.

Specifically, as shown in FIG. 3, multiple adjacent display modules 101 are arranged in a region corresponding to one first functional module 102, wherein one first functional module 102 can be arranged in all or part of the gaps between the display units 1011 in adjacent display modules 101. The first functional modules 102 with the same function can be arranged adjacent to each other or spaced apart from each other. For example, one first functional module 102 is arranged in all gaps between the display units 1011 in four adjacent display modules 101, and two first functional modules 102 with the same function are spaced apart.

As shown in FIG. 4, the first functional modules 102 with different functions can be filled in regions corresponding to different numbers of the display modules 101, and the first functional modules 102 with different functions can be arranged spaced apart or adjacent to each other. For example, the first functional modules 102 comprise a first functional module E 102e and a first functional module F 102f having different functions, and the first functional module E 102e is filled in gaps between the display units 1011 of four adjacent display modules 101. The first functional module F 102f is filled in gaps between the display units 1011 of two adjacent display modules 101, and the first functional module E 102e and the first functional module F 102f are spaced apart from each other.

It should be noted that the solutions (scenarios) shown in FIG. 1, FIG. 3, and FIG. 4, in which the first functional modules 102 are arranged in the display modules 101, can be combined arbitrarily to make full use of a space between the display units 1011 of the display modules 101.

It should be noted that, when to integrate the first functional module 102 into a distributed display device, in order to achieve a better integration effect and use conventional display panel manufacturing processes, conventional display panel technology should be used as much as possible to produce the first functional module 102; however, due to limitations on types of components that can be manufactured by the conventional display panel technology and processing capabilities of the components, not all the first functional modules 102 can be realized by the conventional display panel technology. In view of this, in order to make full use of the conventional display panel technology while taking into account the functional requirements of the first functional module 102, the first functional module 102 can be integrated in the following manner.

Preferably, please refer to FIG. 5, which is a first cross-sectional view of the display device according to one embodiment of the present application. At least one first functional module 102 is fixed to the display device 100, so that the at least one first functional module 102 is arranged in a distributed manner in the display device 100, and a manufacturing process of the display device 100 is also simplified. A method of fixing the first functional module 102 to the display device 100 comprises, but is not limited to, welding, interface coupling, or conductive adhesive bonding.

The first functional module 102 can also include at least one first sub-functional module (not shown) fixed to the display device 100, and/or at least one second sub-functional module (not shown) disposed in the display device 100, so that the first functional module 102 is arranged in a distributed manner in the display device 100, and as a result, parts(e.g., the second sub-functional module) of the first functional module 102 can be manufactured at the same time of performing conventional display panel techniques for manufacturing transistors and capacitors, and difficult functional modules (e.g., the first sub-functional module) are directly fixed to the display device with a chip or the like.

It should be noted that the first sub-functional module can be a module with an independent function, or a module including multiple components and no independent function. The second sub-functional module can be a module with an independent function, or a module with multiple components and no independent function. Specifically, when the first sub-functional module is a module with an independent function, the first sub-functional module can be one or more of a source driver chip, a gate driver chip, a timing control chip, a ROM chip, a RAM chip, a CPU chip, an artificial intelligence chip, an antenna chip, an audio chip, a sensor chip, a power chip, and etc. When the second sub-functional module is a module with an independent function, the second sub-functional module can also be one or more of a source driver chip, a gate driver chip, a timing control chip, a ROM chip, a RAM chip, a CPU chip, an artificial intelligence chip, an antenna chip, an audio chip, a sensor chip, a power chip, and etc. The sensor chip includes, but is not limited to, an optical sensor chip and a pressure sensor chip. The first sub-functional module is different from the second sub-functional module.

The first functional module 102 comprises at least one first functional element 1024 fixed to the display device 100, and/or at least one second functional element 1025 disposed in the display device 100, so that the second functional element 1025 with a predetermined processing capability can be produced by using a conventional display panel manufacturing process. When a device produced by using the conventional display panel manufacturing process cannot satisfy a need for the predetermined processing capability, the external first functional element 1024 is directly fixed to the display device 100. The second functional element 1025 can be arranged between two adjacent display units 1011. The first functional element 1024 comprises one or more of inductors, resistors, capacitors, and transistors, and the second functional element 1025 comprises one or more of inductors, resistors, capacitors, and transistors. For example, the first functional element 1024 can be a resistor, and the second functional element 1025 can be a transistor. The first functional element 1024 is different from the second functional element 1025.

Preferably, as shown in FIG. 6, the first functional module 102 comprises at least one first functional element 1024 fixed to the display device 100 and at least one second functional element 1025 disposed in the display device 100. The second functional element 1025 is manufactured in a same process for manufacturing the pixel driver circuit of the display unit 1011 and is located inside the display device 100. When the first functional element 1024 is a resistor or a capacitor, it can be fixed to the display device 100 by welding or the like.

It should be noted that the solutions (scenarios) shown in FIGS. 5 and 6 regarding the first sub-functional module and the second sub-functional module can also be combined arbitrarily. For example, at least one first sub-functional module can be fixed to the display device 100, and at the same time, at least one second functional element 1025 is disposed in the display device 100. Alternatively, at least one first functional module 102 is fixed to the display device 100, and at least one second sub-functional module is disposed in the display device 100.

In the present embodiment, although full-screen display is the current and future development trend, it does not rule out the need to set non-display regions in some special conditions. Referring to FIGS. 1, 3, and 4, in order to better utilize a space of these non-display regions, the display device 100 further comprises a non-display region 100b, the display device 100 further comprises at least one second functional module 103, at least one second functional module 103 is disposed in the non-display region 100b, each second functional module 103 receives a corresponding second functional signal, and a parameter of each second functional signal is less than or equal to a peak processing capability of the corresponding second functional module 103, so that at least one second functional module 103 located in the non-display region 100b independently receives the corresponding signal. That is to say, a functional device arranged in the non-display region 100b is also split into a plurality of second functional modules 103 so as to provide the display device with a distributed system integrated in the display panel, and furthermore, each second functional module 103 receives a second functional signal that it can process, thereby providing a basis for the display device with the distributed system integrated in the display panel to realize high-resolution display. Wherein, the second functional module 103 comprises one or more of a source driving module, a gate driving module, a timing control module, a ROM module, a RAM module, a CPU module, an artificial intelligence module, an antenna module, an audio module, a sensor module, and a power module.

In practice, the second functional module 103 is the same as the first functional module 102, at least one second functional module can be fixed to the display device 100; a portion of the at least one second functional module 103 can be fixed to the display device 100, and a portion of the second functional module 103 can also be disposed in the display device 100. Regarding the portion of the second functional module 103 fixed to the display device 100, it can be a sub-module of the second functional module 103 fixed to the display device 100, or it can be a single element (e.g., a resistor, a capacitor, a transistor, an inductor) of the second functional module 103 fixed to the display device 100. Regarding the portion of the second functional module 103 arranged in the display device 100, it can be a sub-module of the second functional module 103 disposed in the display device 100, or it can be a single element (e.g., a resistor, a capacitor, a transistor, and an inductor) of the second functional module 103 disposed in the display device 100.

In the present embodiment, referring to FIG. 7, the display device 100 further comprises a signal splitting module 104. The signal splitting module 104 is arranged in the non-display region 100b. The signal splitting module 104 is configured to split a signal 100c received by the display device 100 into a processing signal 100d that can be processed by the display device 100. The processing signal 100d comprises the display signal, the first functional signal, and the second functional signal.

In the present application, the signal 100c received by the signal splitting module 104 is split to obtain the processing signal 100d that can be processed by the display module 101, the first functional module 102, and the second functional module 103, and the display device 100 is split into multiple display modules 101 and multiple functional modules (comprising multiple first functional modules 102 and multiple second functional modules 103), each module independently controls and works, and multiple modules are combined to support operations of the display device with a high-resolution distributed system integrated in the display panel.

In practice, the signal splitting module 104 is arranged in the display device 100. The signal splitting module 104 splits the received signal 100c into multiple groups of parallel processing signals 100d after one splitting, and a signal frequency of the processing signal 100d (e.g., 10 MHz to 300 MHz) is lower than a signal frequency(e.g., 12 Gbps and above) of the signal 100c received by the signal splitting module 104, and the processing signal 100d can be processed by the display module 101 and the functional module, so that the display device 100 can processing high-frequency signals, and thereby can process a large amount of data and achieve high-resolution display. It should be noted that, the signal splitting module 104 can also be set independently from the display device 100, the signal splitting module 104 splits once the received signal 100c outside the display device 100 to obtain the processing signal 100d, and through communication connection, the processing signal 100d is transmitted to the display module 101 and functional modules (the first functional module and the second functional module) in the display device 100; or, a portion of the signal splitting module 104 is disposed in the display device 100, and another portion of the signal splitting module 104 is set independently from the display device 100 and is communicatively connected with the display device 100. The portion of the signal splitting module 104, set independently from the display device 100, transmits the signal 100c received by the signal splitting module 104 to the portion of the signal splitting module 104 disposed in the display device 100 after first splitting of the signal 100c. The above-mentioned processing signal 100d is obtained after second splitting by the portion of the sub-module 104 disposed in the display device 100.

The present application also provides a display system 200. The display system 200 comprises at least one display device 100 mentioned above and at least one signal splitting module 104. The signal splitting module 104 is configured to split a signal, received by the signal splitting module 104, into a processing signal. The processing signal is a signal that can be processed by the display module and the functional module, and the signal is, for example, the display signal, the first functional signal, and the second functional signal as mentioned above.

In the present embodiment, referring to FIGS. 8 to 11, there can be one or more signal splitting modules 104, the signal splitting module 104 is disposed in the display device 100, and/or the signal splitting module 104 is arranged independently from the display device 100 and communicatively connected with the display device 100. When the signal splitting module 104 is disposed in the display device 100, the signal splitting module 104 can be fixed to the display device 100. When the signal splitting module 104 is arranged independently and communicatively connected with the display device 100, communication connection can be realized by electromagnetic conversion of an inductor coil for signal transmission, or a microstrip antenna for signal transmission.

The signal splitting module 104 and the display device 100 are connected by wires, and/or the signal splitting module 104 and the display device 100 are connected wirelessly. The signal splitting module 104 is disposed in the display device 100 and can be connected to the display device 100 through wires. When the signal splitting module 104 is arranged independently from the display device 100, the signal splitting module 104 can communicate with the display device 100 through wireless communication to transmit signals.

In the display system 200, each display device 100 further comprises a plurality of first functional modules, each first functional module is configured to receive a corresponding first functional signal, each first functional module comprises a plurality of first functional units, and a parameter of each first functional signal is less than or equal to a peak processing capability of the corresponding first functional module, wherein the processing signal 100d comprises the first functional signal.

In each display device 100 of the display system 200, at least one first functional module is arranged in an area corresponding to one display module, and/or multiple display modules are arranged in an area corresponding to one first functional module.

In each display device 100 of the display system 200, at least one first functional module is fixed to the display device 100.

In each display device 100 of the display system 200, the first functional module comprises: at least one first sub-functional module fixed to the display device; and/or at least one second sub-functional module disposed in the display device.

In each display device 100 of the display system 200, the first functional module comprises: at least one first functional element fixed to the display device 100, and/or at least one second functional element disposed in the display device 100. The first functional element comprises one or more of inductors, resistors, capacitors, and transistors; and the second functional element comprises one or more of inductors, resistors, capacitors, and transistors.

Each display device 100 in the display system 200 comprises a display region and a non-display region, a plurality of first functional modules and a plurality of display modules are arranged in the display region. The display device further comprises at least one second functional module, wherein the at least one second functional module is arranged in the non-display region, each second functional module receives a corresponding second functional signal, and a parameter of each second functional signal is less than or equal to a peak processing capability of the corresponding second functional module. The processing signal 100d also comprises a second functional signal.

In the present embodiment, when the display system 200 comprises multiple display devices 100, the multiple display devices 100 can be assembled and spliced into a large-size spliced display device. Each display device 100 is provided with a coupling interface (not illustrated), and multiple display devices 100 are coupled to each other through the coupling interfaces. The following describes the display system 200 of the present application by taking the display system 200 including four display devices 100 as an example, but the number of the display devices 100 included in the display system 200 is not limited to four.

The present embodiment is shown in FIG. 8, which is the first schematic view of the display system of the present application. Each signal splitting module 104 is set in one display device 100, each signal splitting module 104 is set in the non-display region of the corresponding display device 100, and each signal splitting module 104 splits once the signal 100c received in the display device 100 to obtain multiple processing signals 100d. The processing signals 100d are allocated to each independent display module 101 and functional module (including the first functional module, the second functional module, the first functional element, or the second functional element). Wherein, the signal frequency of the signal 100c received by each signal splitting module 104 is greater than the signal frequency of each processing signal 100d.

The present embodiment is shown in FIG. 9, which is a second schematic view of the display system of the present application. The signal splitting module 104 is a functional module. The signal splitting module 104 can also be disposed in the display region of the display device 100, and the signal splitting module 104 is disposed in the gap between the display units 1011 of the multiple display modules 101. The signal splitting module 104 of the entire display system 200 can be installed in the display region of one display device 100; the signal splitting module 104 of the entire display system 200 can also be arranged in a distributed manner in the display regions of multiple display devices 100.

The present embodiment is shown in FIG. 10, which is a third schematic view of the display system of the present application. When the signal splitting module 104 is arranged independently and communicatively connected with the display device 100, the signal splitting module 104 splits once the received signal 100c outside the display device 100 to obtain the processing signals 100d and distribute the processing signals 100d to each of the independent display module 101 and functional modules of each display device 100. Wherein, the signal frequency of the signal 100c received by each signal splitting module 104 is greater than the signal frequency of each processing signal 100d.

The present embodiment is shown in FIG. 11, which is a fourth schematic view illustrating the display system of the application. The signal splitting module 104 comprises a first signal splitting module 1041 and a second signal splitting module 1042. The first signal splitting module 1041 is configured to split the signal 100c received by the signal splitting module 104 into an intermediate signal 100e. The signal splitting module 1042 is configured to receive the intermediate signal 100e and split the intermediate signal 100e into the processing signals 100d, and the processing signals 100d are transmitted to the display module 101 and the functional modules. The first signal splitting module 1041 is arranged independently and is communicatively connected with multiple display devices 100, the second signal splitting module 1042 is disposed in the display device 100, and one display device 100 is provided with one second signal splitting module 1042. The signal frequency of the signal 100c received by the signal splitting module 104 is greater than a signal frequency of the intermediate signal 100e, and the signal frequency of the intermediate signal 100e is greater than the signal frequency of the processing signal 100d.

It can be known from the above that, the signal splitting module 104 is used as a functional module, and when the signal splitting module 104 is entirely or partially disposed in the display device 100, the portion of the signal splitting module 104 disposed in the display device 100 can be set in the display region or non-display region of the display device 100.

The present application also provides a distributed functional system. The distributed functional system comprises a plurality of functional modules and a plurality of signal splitting modules. Each functional module is configured to receive a corresponding functional signal, and a parameter of each functional signal is less than or equal to a peak processing capability of the corresponding functional module. The signal splitting module is configured to split the signal it receives into functional signals, so that the distributed functional system can split high-frequency functional signals into low-frequency functional signals through the signal splitting module. The functional modules can process the corresponding low-frequency functional signals, thus improving the ability of the distributed functional system to process the signal.

It should be noted that the distributed functional system can be used not only in the above-mentioned display device, but also in audio devices, smart home systems, intelligent vehicle control systems, aircraft systems, and so on. Among them, smart home systems include, but are not limited to, refrigerators, monitors, and sofas.

The display device comprises multiple distributed display modules, each display module receives its own corresponding display signal, and each display module comprises multiple display units, and each first functional unit is integrated between adjacent ones of the display units to realize the functional integration in the display device. A parameter of each display signal is less than or equal to peak processing capability of the corresponding display module, so that the above-mentioned distributed system-on-panel (SOP) display device can realize the full high definition (FHD) displays or higher-than-FHD resolution displays.

The above embodiments are only for ease of understanding the technical solutions and main ideas of the present application. Those of ordinary skill in the art can modify the technical solutions recorded in the foregoing embodiments, or modify some of the technical solutions, or equivalently replace some of the features. The essence of such modifications or replacements in corresponding technical solutions provided by those of ordinary skill in the art do not deviate from the protection scope of the technical solutions of the embodiments of the present application.

What is claimed is:

1. A display device, comprising:
a plurality of display modules, wherein each of the display modules is configured to receive a corresponding display signal, each of the display modules comprises a plurality of display units, a parameter of each of the display signals is less than or equal to a peak processing capability of the corresponding display module; and
a plurality of first functional units, each of the first functional units arranged between adjacent ones of the display units.

2. The display device according to claim 1, further comprising a plurality of first functional modules, wherein each of the first functional modules is configured to receive a corresponding first functional signal, each of the first functional modules comprises multiple ones of the first functional units, and a parameter of each of the first functional signals is less than or equal to a peak processing capability of the corresponding first functional module.

3. The display device according to claim 2, wherein at least one of the first functional modules is arranged in an area corresponding to one of the display modules, and/or a plurality of the display modules are arranged in an area corresponding to one of the first functional modules.

4. The display device according to claim 2, wherein at least one of the first functional modules is fixed to the display device.

5. The display device according to claim 2, wherein the first functional module comprises at least one first sub-functional module fixed to the display device, and/or at least one second sub-functional module arranged in the display device.

6. The display device according to claim 2, wherein the first functional module comprises at least one first functional element fixed to the display device, and/or at least one second functional element arranged in the display device.

7. The display device according to claim 6, wherein the first functional element comprises one or more of an inductor, a resistor, a capacitor, and a transistor; and the second functional element comprises one or more of an inductor, a resistor, a capacitor, and a transistor.

8. The display device according to claim 2, wherein the display device comprises a display area and a non-display area, the plurality of first functional modules and the plurality of display modules are arranged in the display area, and the display device further comprises:
at least one second functional module, wherein at least one of the second functional modules is arranged in the non-display area, each of the second functional modules receives a corresponding second functional signal, and a parameter of each second functional signal is less than or equal to a peak processing capability of the corresponding second functional module.

9. The display device according to claim 8, further comprising a signal splitting module for splitting a signal received by the display device into a processing signal to be processed by the display device, wherein the processing signal comprises the display signal, the first functional signal, and the second functional signal.

10. The display device according to claim 2, wherein the first functional module comprises one or more of a source driving module, a gate driving module, a timing control module, a read-only memory (ROM) module, a random access memory (RAM) module, a central processing unit (CPU) module, an artificial intelligence module, and an antenna module, an audio module, a sensor module, and a power module.

11. A display system, comprising at least one display device according to claim 1.

12. The display system according to claim 11, further comprising at least one signal splitting module configured to split a signal received by the signal splitting module into a processing signal, wherein the processing signal comprises a display signal.

13. The display system according to claim 12, wherein the signal splitting module is arranged in the display device, and/or the signal splitting module is independently arranged and is communicatively connected with the display device.

14. The display system according to claim 12, wherein the signal splitting module comprises a first signal splitting module and a second signal splitting module, the first signal splitting module is configured to split a signal received by the signal splitting module into intermediate signals, and the second signal splitting module is configured to split the intermediate signal into the processing signals.

15. The display system according to claim 12, wherein the display system comprises the plurality of display devices, each of the display devices is provided with a coupling interface, and the plurality of display devices are coupled to each other through the coupling interfaces.

16. The display system according to claim 12, wherein the signal splitting module and the display device are connected through wires, and/or the signal splitting module and the display device are connected wirelessly.

17. A distributed functional system, comprising:
a plurality of functional modules, wherein each of the functional modules is configured to receive a corresponding functional signal, and a parameter of each of the functional signals is less than or equal to a peak processing capability of the corresponding functional module; and
a signal splitting module configured to split a signal received by the signal splitting module into the functional signals.
